(19) United States
(12) Patent Application Publication
(10) Pub. No.: US 2007/0269786 A1
(43) Pub. Date: Nov. 22, 2007

(54) Game Method And Game System For Recruiting And Entering A School Of Higher Grade

(76) Inventor: Joong-Yang Jeon, Seoul (KR)

Correspondence Address: REED SMITH LLP, 3110 FAIRVIEW PARK DRIVE, SUITE 1400, FALLS CHURCH, VA, 22042, US

(21) Appl. No.: 11/667,659

(22) PCT Filed: Nov. 24, 2005
(86) PCT No.: PCT/KR05/03983

§ 371 Date: May 14, 2007

(30) Foreign Application Priority Data
Nov. 24, 2004 (KR) 10 2004-0096908

(51) Int. Cl. G06Q 30/00

(52) U.S. Cl. 434/323

(57) ABSTRACT

Provided are a method and a system for playing a game helping get a job and a method and a system for playing a game helping entering into a university or a school of higher grade. The present invention, through the game, provides an advantage of enabling a job applicant to get a basic understanding of a culture of a company which he/her actually wants to enter into and to get in advance familiar with a style of a written examination and an interview required by the company. More specifically, the job applicant may be in advance familiar with employment requirements provided by the company and he/she, through the game, may be motivated to study for the examination and the interview in an interesting way. Also, the company, through the game, may employ a competent person with a good grounding required of its employees. Also, the present invention, through the game, provides another advantage of enabling an applicant who wants to enter into a university or a school of higher grade to grasp his/her aptitude and select his/her major suitable for his/her learning ability judged through evaluation of a result of briefly studying a plurality of subjects according to his/her grasped aptitude. More specifically, the applicant may be motivated to have interest in studying for entrance into a university or a school of high grade and may obtain a substantial guidance on the entrance into a university or a school of higher grade, thus increasing his/her learning efficiency.

### TECHNICAL FIELD

The present invention relates to a method and a system for playing a game helping get a job and enter into a university or a school of higher grade, and more particularly, to a method and a system for helping get a job and enter into a university or a school of higher grade depending on a result of performing a game after playing the game helping get a job and enter into a university or a school of higher grade.

### BACKGROUND ART

A conventional on-line method that helps get a job is that a job applicant only uploads over the Internet a statement of his/her personal history and background on a job-wanted board and a person in charge of personnel at a company which plans to recruit a person searches the job-wanted board for a prospective employee. Another conventional on-line method that helps get a job is that a job applicant writes required information on a given job application, such as his/her personal history and background over the Internet, a person in charge of personnel at a company writes required information on a given recruiting application, such as a department in need of employment and a monthly or annual salary over the Internet, and the job applicant or the person in charge of personnel at the company searches for the required information on the given recruiting applications or for the required information on the given job applications to look for the company or the job applicant that meets each other's requirements.

However, according to the above methods, the company's entire dependence on the information provided by the job applicant not only makes it difficult to evaluate if the job applicant is actually competent at performing a given job, but also prevents the company from recruiting a person who has a basic grounding it requires.

On the other hand, the way that a company recruits a person is comparable with the way that educational institutes such as a university and a graduate school recruit a person. The way that an applicant enters into a university or a school of higher grade is twofold. One is that the applicant takes the learning competence examination, and applies one time for admission to a certain department of a certain university or a certain school of higher grade which he/she wants to enter into, and then the university or the school of higher grade selects the applicant based on both of a result of the learning competence examination and a result of examinations taken in a high school. The other is that a university or a school of higher grade selects at any time the applicant of remarkable ability who meets its specific admission requirements.

However, most of applicants take lectures at a private preparatory school, or study by themselves in order to obtain a good result of the examinations. This educational system that focuses on entrance into a university or a school of high grade cannot motivate an applicant to have interest in study, and cannot develop his/her talent and aptitude, thus causing a problem of spreading uniform education suitable only for admission to the university or the school of high grade.

### DISCLOSURE OF INVENTION

### Technical Problem

A purpose of the present invention is to provide solutions to problems with the conventional on-line methods for helping get a job and enter into a university or a school of high grade. The present invention provides a method and a system for playing a game helping get a job. The method and the system enable a job applicant to get a basic understanding of a culture of a company which he/her wants to enter into and to get in advance familiar with a style of a written examination and an interview required by the company. Thus, the job applicant may be familiar with employment qualifications required by the company in advance and he/she, through the game, may be motivated to study for the examination and the interview in an interesting way. Also, the company, through the game, may recruit a competent person with a good grounding required of its employees.

The present invention also provides a method and a system for helping enter into a university or a school of higher grade. The method and the system enable an applicant who wants to enter into a university or a school of higher grade to beforehand study on line for knowledge and common sense required by the university or the school of higher grade and for introductory information about a department of a university or a school of higher grade which he/she wants to enter into, and make it possible to evaluate a level of his/her educational accomplishment after studying on line for admission qualifications. Thus, the applicant may be in advance familiar with admission qualifications required by the university or the school of higher grade which he/she wants to enter into, and he/she, through the game, may be motivated to study in an interesting way. Also, the university or the school of higher grade, through the game, may select a competent applicant with a good grounding and an ability to accomplish a high level of school records, which are required by the university or the school of higher grade.

### Technical Solution

According to an aspect of the present invention, there is provided a system for playing a game helping get a job, including a database server storing information on a member company including basic and statistical company information, a question/mission which is provided by the member company, personal information on a user, personal history information on a user, evaluation information on a user and payment information on a user, a game server transmitting to a user terminal the information on the member company and the question and mission provided by the member company according to the user's selection value, comparing a result of the user's performing the question and mission with an exemplary answer to the question/mission stored in the database server, generating evaluation result data, making a list of high ranked users who belong to a specified high ranking based on the evaluation result data, and transmitting the list of users, a member company server transmitting the information on the member company and the question/mission provided by the member company to the game server, storing the information and the question/mission in the database server, and receiving the list of high ranked users, and a user terminal receiving the user's selection value indicating a company which the user wants to enter into and a department of the company in response to the user's operation, transmitting the user's selection value to the game server, and transmitting to the game server the result of the user's performing the question/mission received from the game server.

According to an aspect of the present invention, there is provided a method for playing a game helping get a job, comprising steps of: (a) allowing a game server to receive a selection value for a company which a user wants to enter into and a department of the company from a user terminal; (b) allowing the game server to read a question/mission stored in connection with the company and the department of the company represented by the selection value from a database server working in association with the game server and transmit the read question/mission to the user terminal; (c) allowing the game server to receive a result of performing the question/mission from the user terminal and compare the result with an exemplary answer to the question/mission read from the database server to generate a revaluation result data; and (d) allowing the game server to determine a user ranking according to the revaluation result data and provide information on a user who belongs to a specified ranking to a server of a member company which provides the question/mission.

According to an aspect of the present invention, there is provided a system for helping enter into a university or a school of higher grade, including a database server storing information on a university including basic and statistical university information, question/mission data classified according to a subject, and question/mission data classified according to a major, which are received from a university server and storing personal information, personal history information, evaluation information and payment information on an applicant who wants to enter into a university or a school of higher grade, and a game server transmitting the information on the university and the question/mission data to a user terminal according to a selection value received from the user terminal of the applicant, comparing a result of performing the question/mission with an exemplary answer to the question/mission stored in the database server to generate evaluation data, making a list of high ranked users who belong to a specified ranking, and transmitting the list to a university server.

According to an aspect of the present invention, there is provided a method for helping enter into a university or a school of higher grade, comprising steps of: (a) allowing a game server to receive university selection information from a user terminal operated by an applicant who want to enter into a university or a school of high grade, to make a list of subjects suitable for the applicant based on a list of subjects stored, in connection with a university represented by the university selection information, in a database server working in association with the game server, to transmit the list of subjects to the user terminal, and to receive selection value for at least more than one subject; (b) allowing the game server to read moving pictures data on each of selection subjects and question/mission data from the database server, to transmit the moving picture data and the question/mission data to the user terminal, and to receive a first result of performing the question/mission from the user terminal to generate a first evaluation data; (c) allowing the game server to make a list of recommended majors corresponding to subjects getting grades exceeding a specified grade based on a first evaluation data exceeds a specified grade, to transmit the list of recommended majors to the user terminal, to read a major-based question/mission data corresponding to the selected major from the database server and to transmit the major-based question and mission data to the user terminal after receiving selection information on the major from the user terminal; and (d) allowing the game server to receive a second result of performing the question/mission from the user terminal to generate a second evaluation data, and to generate ranking information on the applicant based on the second evaluation data in terms of the major to transmit the ranking information to a university server providing the major-based question/mission data.

### Advantageous Effects

The present invention, through the game, provides an advantage of enabling a job applicant to get a basic understanding of a culture of a company which he/her actually wants to enter into and to get in advance familiar with a style of a written examination and an interview required by the company. More specifically, the job applicant may be in advance familiar with employment requirements provided by the company and he/she, through the game, may be motivated to study for the examination and the interview in an interesting way. Also, the company, through the game, may employ a competent person with a good grounding required of its employees.

The present invention, through the game, provides another advantage of enabling an applicant who wants to enter into a university or a school of higher grade to grasp his/ her aptitude and select his/her major suitable for his/her learning ability which is judged through evaluation of a result of briefly studying a plurality of subjects, according to his/her grasped aptitude. More specifically, the applicant may be motivated to have interest in studying for entrance into a university or a school of high grade and may obtain a substantial guidance on the entrance into a university or a school of high grade, thus increasing his/her learning efficiency. The educational institute such as a university may select the applicant after comprehensively evaluating a performance result obtained by the applicant by registering in advance learning materials and a question/mission over the Internet and conducting an on-line interview with the applicant who made a good showing in performing the question/mission. Thus, the educational institute may select a competent applicant who has a good grounding obtained through the game and an ability to accomplish a high level of school records required by the university.

### BRIEF DESCRIPTION OF THE DRAWINGS

FIG. 1 is a block diagram showing in detail a configuration of a system for playing a game helping get a job according to a preferable embodiment of the present invention.

FIG. 2 is a detailed block diagram showing in detail configurations of a game server and a database server as shown in FIG. 1.

FIG. 3 and FIG. 4 are flowcharts explaining a method for playing a game helping get a job according to a preferable embodiment of the present invention.

FIGS. 5 to 7 are examples in which virtual cities are created according to a method for playing a game.

FIGS. 8 to 15 are screen examples of performing a question/mission according to a method for playing a game.

FIG. 16 is a block diagram showing a configuration showing a system for playing a game helping enter into a university or a school of higher grade according to a preferable embodiment of the present invention.

FIG. 17 is a block diagram showing in detail configurations of a game server and a database server as shown in FIG. 16.

FIGS. 18 to 20 are flowcharts explaining a method for playing a game helping enter into a university or a school of higher grade according to a preferable embodiment of the present invention.

FIGS. 21 to 25 are screen examples of performing a question/mission according to a method for playing a game helping enter into a university or a school of higher grade.

### MODE FOR THE INVENTION

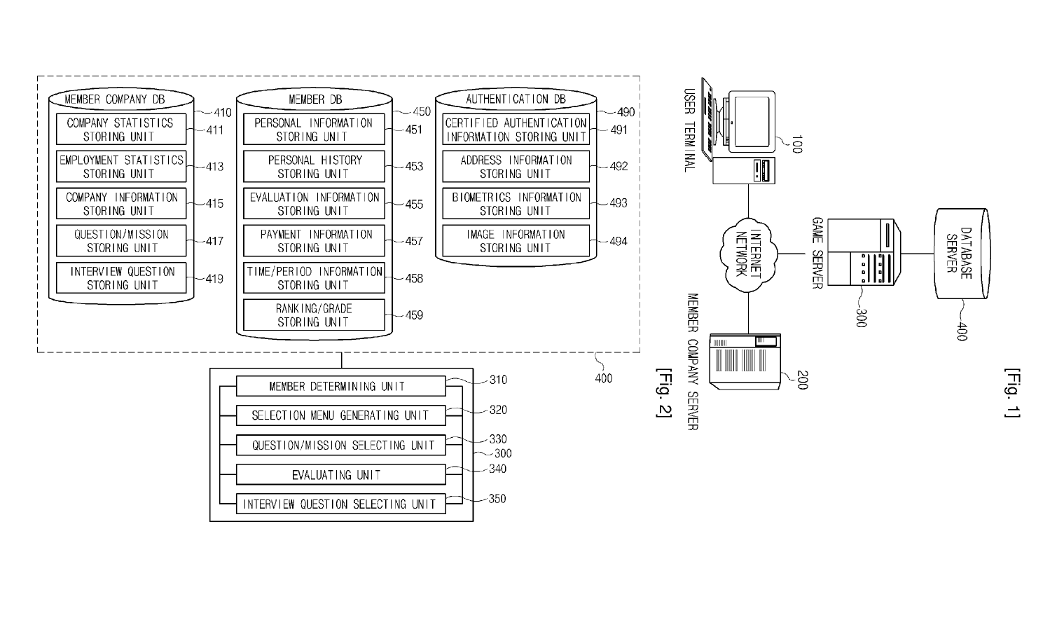

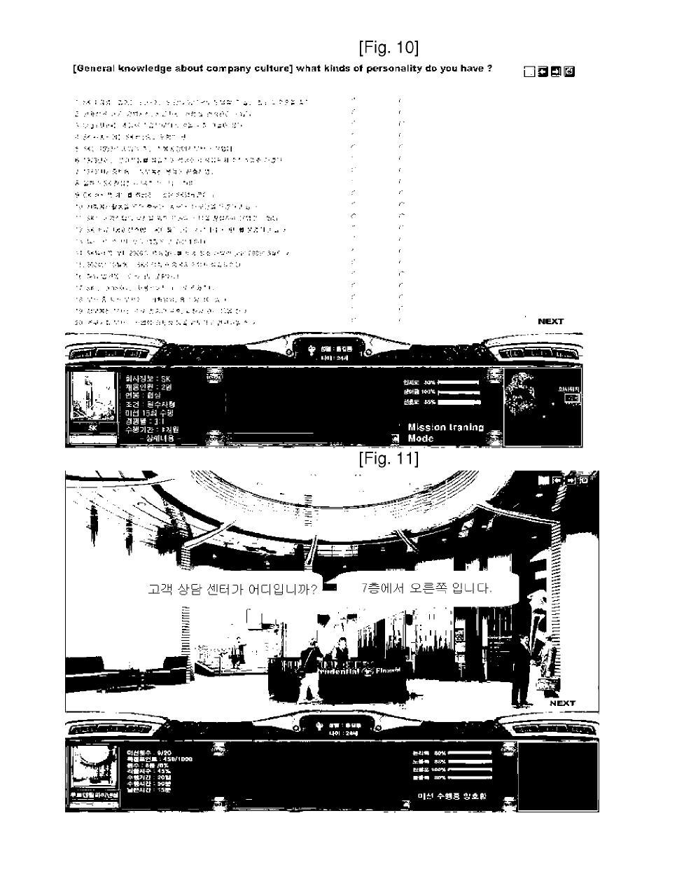

Preferable embodiments of the present invention will now be described more fully with reference to FIGS. 1 to 15 of the accompanying drawings.

FIG. 1 is a block diagram showing a configuration of a system for playing a game helping get a job according to a preferable embodiment of the present invention. Referring to FIG. 1, the system for playing a game helping get a job according to the present invention includes a game server 300, a database server 400 working in association with the game server 300, a user terminal 100, and a member company server 200.

The database server 400 includes a member company database 410, a member database 450, and an authentication database 490. The member company database 410 stores member company information including basic and statistical company information and a question/mission provided by the member company. The member database 450 stores personal information, personal history information, evaluation information and payment information on a job applicant. The authentication database 490 prevents other people other than a legitimate job applicant from playing the online game and prevents the individual information on the job applicant from being leaked.

The game server 300 grants registration and entrance of a member company and a member, transmits the information and the question/mission stored in the database server 400 to the user terminal 100 according to the applicant's selection value to provide the information and the question/mission to the job applicant, and transmits to the member company server a list of high ranked job applicants who belong to a specified ranking as a result of performing the question/mission among job applicants.

The member company server 200 provides the information on the member company and the question/mission provided by the member company to the game server 300 and receives from the game server 300 the list of high ranked job applicants who belong to a specified ranking as a result of performing the question/mission provided by the member company, along with the personal information and the personal history information on the high ranked job applicants.

The user terminal 100 selects a company which wants to recruit a new person and a department of the company and transmits the result of performing the question/mission received from the game server 300 to the game server 300.

FIG. 2 is a block diagram showing in detail configurations of the game server 300 and the database server 400 as shown in FIG. 1. Referring to FIG. 2, the database server 400 includes the member company database 410, the member database 450, and the authentication database 490.

The member company database 410 includes a company statistics storing unit 411, an employment statistics storing unit 413, a company information storing unit 415, a question/mission storing unit 417, and an interview question storing unit 419.

The company statistics storing unit 411 stores statistical information on the company that is announced every year, such as a level of recognition, a level of preference, and a level of an employee's annual salary. The employment statistics storing unit 413 stores statistical employment information on to the company, such as the number of applicants who apply for a job every year, the number of recruited employees, a percentage of employment competition, school records of applicants, applicants' averaged records of foreign language proficiency test, distribution of schools from which applicants graduated, and a percentage of on-line/off-line employment competition.

The company information storing unit 415 stores basic information on the company, such as a company name, a name of chief executive officer, a business registration number, basic information on financial status.

The question/mission storing unit 417 stores the question/mission received directly from the member company according to a department. The interview question storing unit 419 stores an anticipated question for a mock interview that is assigned to the applicants of high ranked records.

The member database 450 includes a personal information storing unit 451 storing personal information on the member, a personal history information storing unit 453 storing person history information on the member, an evaluation information storing unit 455 storing data on revaluation of a result of performing the method for playing the on-line game helping get a job according to the present invention, including a grade obtained as a result of performing the question/mission according to a department that the member applies for, a standing of the member, a ranking of the member in percentage terms, and so forth, a payment information storing unit 457 storing payment information on the member, a time/period information storing unit 458 storing an amount of time and a period taken to perform the question/mission, and a ranking/grade information storing unit 459 storing a ranking-based grade corresponding to the ranking which the member obtained as a result of performing an individual mission or a whole mission.

The authentication database 490 includes a certified authentication information storing unit 491, an address information storing unit 492, a biometrics information storing unit 493, and an image information storing unit 494.

The certified authentication information storing unit 491 stores authentication information such as a certificate of authentication issued by the Financial Supervisory Commission or a bank. The address information storing unit 492 stores information which makes it possible to identify the user terminal, such as the user terminal's IP (Internet Protocol) address or MAC (Media Access Control) address.

The biometrics information storing unit 493 stores fingerprint recognition information, iris recognition information, and gene recognition on a user to be used in a living body recognition device, such as a fingerprint recognition mouse, installed in the user terminal.

The image information storing unit 494 stores a moving picture taken by an image camera installed in the user terminal to prevent an improper act, showing an actual situation where the user answers the question or performs the mission.

The game server 300 includes a member determining unit 310, a selection menu generating unit 320, a question/mission selecting unit 330, an evaluating unit 340 and an interview question selecting unit 350.

The member determining unit 310 receives the basic company information, the statistical information on employment, and the basic employment information required of a member company from a company which applies for membership, determines if the company is registered as a member company according to a specified regulation. The member determining unit 310 also receives the personal information, the personal history information and the payment information on the job applicant from the user terminal 100, and determines if the job applicant is registered as a member according to a specified regulation.

The selection menu generating unit 320 searches the member company database 410, generates a type of employment which the job applicant looks for, a type of a company which the job applicant applies for a job with, a list of companies which belong to the type of the selected company, and a list of departments of the selected company which are in need of employment of a new person, transmits the type of employment, the type of a company, the list of companies, and the list of departments to the user terminal 100, and receives a selection value.

The question/mission selecting unit 330 searches the question/mission storing unit 417 of the member company database 410 according to the selection value received from the user terminal 100, selects the question/mission corresponding to the department of the company which the job applicant selects, and transmit the question/mission to the user terminal 100.

The evaluating unit 340 receives answer information on the question/mission received from the user terminal 100, compares the answer information with an exemplary answer stored in the question/mission storing unit 417 to calculate a grade, and evaluates a result of performing the question/mission.

The interview question selecting unit 350 searches the interview question storing unit 419 of the member company database 410 according to a revaluation result produced by the evaluating unit 340, transmits to the user terminal 100 a mock interview question provided by the member company with which the job applicant applies for a job, receives the answer from the user terminal 100, and transmits a grading result.

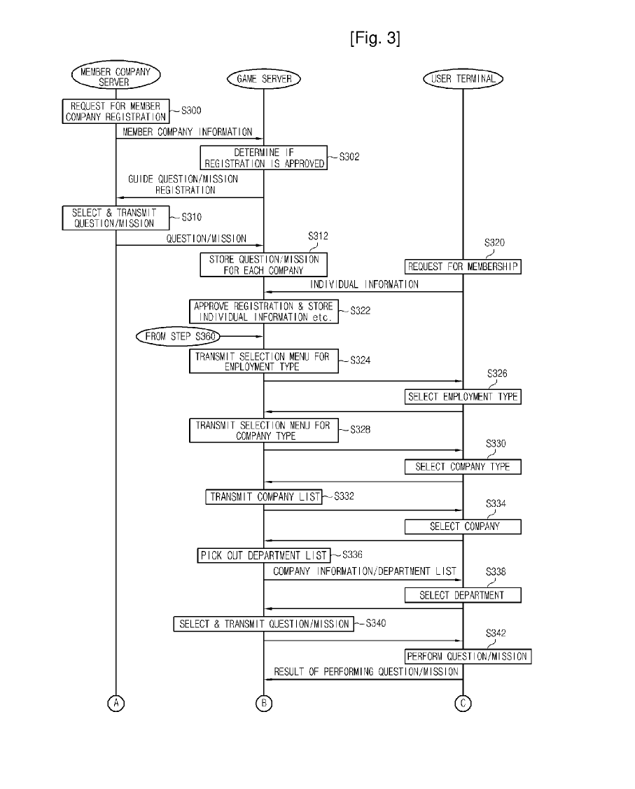

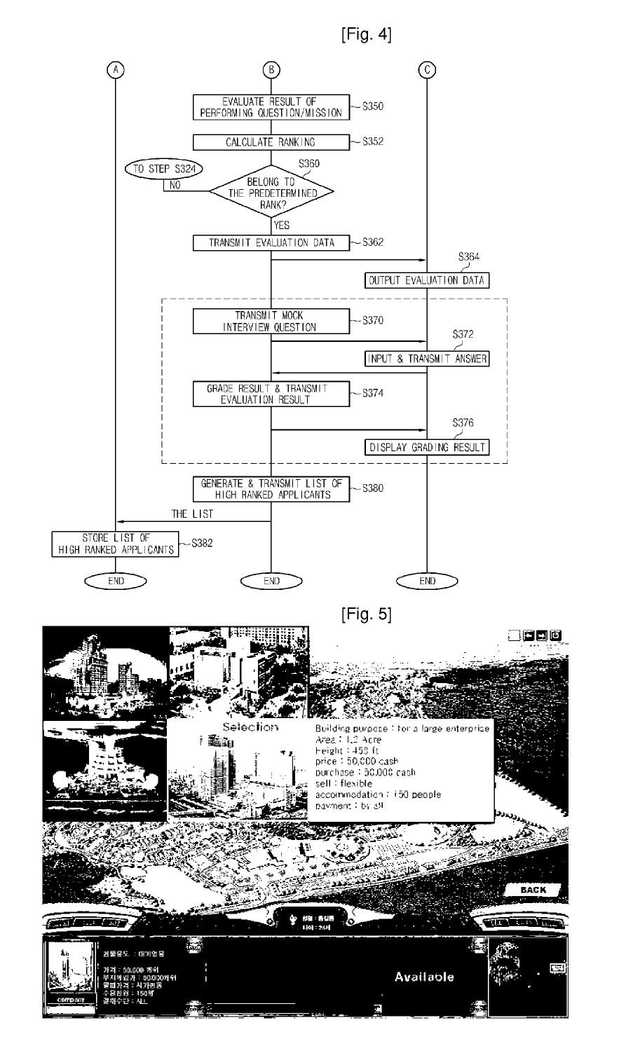

FIGS. 3 and 4 are flowcharts explaining a method for playing a game helping get a job according to a preferable embodiment of the present invention. Referring to FIG. 3, there is provided a method for playing a game helping get a job according to the present invention, where a member company server 200 of the company connects to a game server 300 over the Internet, selects a company member registration menu on a main menu displayed in a main WEB page which a game server 300 displays on the member company server 200, requests the game server 300 for a registration of the member company, and transmits to the game server 300 a basic information on the member company required by the game server 300 (S300).

The member company information includes basic company information, statistical information on employment, basic employment information on the company requesting for registration, and so forth. The basic company information includes a name of CEO, a business location, the number of full-time employees, a business registration number, information on financial status, and so forth. The statistical information on employment includes the number of applicants who applied for a job with the company and the number of employed persons, a percentage of employment competition, and so forth. The basic employment information includes employment qualifications, a form of application, and so forth which are necessary when the company recruits a person on-line or off-line. The employment qualifications include information on an academic background, a career record, proficiency in foreign languages, a certificate of qualifications, reward and punishment, a certificate of a person of merit, and a certificate of a disabled person.

The member determining unit 310 of the game server 300 receives the member company information from the member company server 200, determines if an application for registration of a member company is approved according to a specified regulation, and transmits to the member company server 200 an WEB page showing how to register the question/mission when the application for registration of a member company is approved (S302).

The member company server 200 receives approval information and transmits information on the question/mission to be provided to the job applicant through the game server 300, to the game server 300 (S310). The question/mission may be in the form of a multiple selection test, a scenario, or a simulation. Each question/mission may be selected according to a variety of business skills to test the variety of business skills, such as an ability to response to needs of a customer, an ability to converse well with someone, an ability to analyze a problem, an ability to deal with a situation, an ability to reason, originality, an ability to speak in foreign language, and so forth. The member company server 200 may attach to each question/mission an identification tag indicating a department which each question/mission is provided by.

The game server 300 outputs the received question/mission to the member company database 410 of the database server 400, and the member company database 410 stores the received question/mission in the question/mission storing unit 417 among storing areas of the company (S312). At this time, the question/mission storing unit 417 detects if the identification tag is attached to the input question/mission. The question/mission storing unit 417 classifies the input question/mission into a common question/mission and stores the input question/mission when the identification tag is not attached to the input question/mission. The question/mission storing unit 417 classifies the input question/mission according to a department indicated by the identification tag and stores the input question/mission when the identification tag is attached to the input question/mission.

There is provided another embodiment of a method for playing an on-ling game helping get a job according to the present invention. The method, as shown in FIG. 5, serves to stir up interest in playing the game, including building a virtual city in a three-dimensional space, and allowing the member company to build a virtual building by renting a certain space from the virtual city after paying a certain rent, or to buy an existing building after paying a charge, at the above described step S300.

In the step S332, which will be described later, a screen image, where an appearance of the building selected by the company in the step S300, displays along with a logo of the company may be transmitted to the user terminal. In the step S334, the selection of the building of the company in the virtual city by the user may make it possible to select the company. Thus, these not only give the company an advertising benefit, but also motivate the job applicant to have interest in playing the game.

In addition, referring to FIG. 5, buildings available for sale may be displayed on the screen when the member company displays a building purchase page in order to buy a building in the existing virtual city, and the price of the building may be displayed when the member company selects one building among the buildings displayed on the screen. In a case where a building site is to be purchased, the building site transaction terms displayed on the screen is similar to the building transaction terms of the building on the screen. When one building available for sale is selected, detailed information on the building, such as a use of the building, a price of the building and a payment method, may be displayed on one portion of the screen. Transaction Information indicating whether or not the building or the building site is still available for sale may be displayed on other portion of the screen to avoid a double transaction among the member companies.

When the job applicant connects to the game server 300 over the Internet using the user terminal 100, the game server 300 displays a main WEB page on the user terminal 100 and the job applicant inputs individual information requested by the game server 300, transmits the individual information to the game server 300 and requests for registration (S320). The individual information on the job applicant includes not only personal information such as a name, a resident registration number, a telephone number, and a home address, but also a personal history information and payment information necessary to make payment of a charge for using the service provided by the present invention.

The member determining unit 310 of the game server 300 receives the individual personal information from the user terminal 100, determines if the job applicant is registered as a member according to the regulation, and outputs the individual information to the member database 450 when the job applicant is determined to be registered as a member. After classifying the individual information into the personal information, the personal history information, and the payment information, the member database 450 stores the personal information, the personal history information, and the payment information in the personal information storing unit 451, the personal history storing unit 453, and the payment information storing unit 457, respectively.

The selection menu generating unit 320 of the game server 300 transmits the selection menu for selecting a type of employment to the user terminal 100 when a member registration is completed (S324). The user terminal 100 receives a selection value for the type of employment on the menu and transits the selection value to the game server 300 (S326). The type of employment is classified into hour-based employment, temporary employment, internship, new recruit employment, experienced recruit employment, HR(preparatory employment) and membership employment. The new recruit employment is for a person without experience in working with a company, who prepares for employment. The experienced recruit employment is for a person with experience in working with other company. The HR(preparatory employment) is for a person such as a student, who is unqualified for a job application for the time being, or prepares for employment qualifications. The membership employment is for the member who uses educational game contents of the present invention.

The selection menu generating unit 320 searches the member company database 410 for a company with a plan for employment according to a type of employment, reads the company with a plan for employment and transmits a selection menu for selecting a type of company to the user terminal 100 to display the selection menu (S328). The selection menu for selecting the type of company is a primary classification of companies according to the type of the company with which a job applicant, i.e., a member applies for a job. The selection menu for selecting the type of company includes a liberal company community, a large company community, a venture company community, and a global company community. The liberal company community includes a company which wants to employ unknown talented people without any employment limitations.

The user terminal 100 receives a selection value for the type of company on the menu and transmits the selection value to the game sever 300 (S330). The selection menu generating unit 320 of the game server 300 displays a list of companies corresponding to the selected type of company to the user terminal 100 (S332).

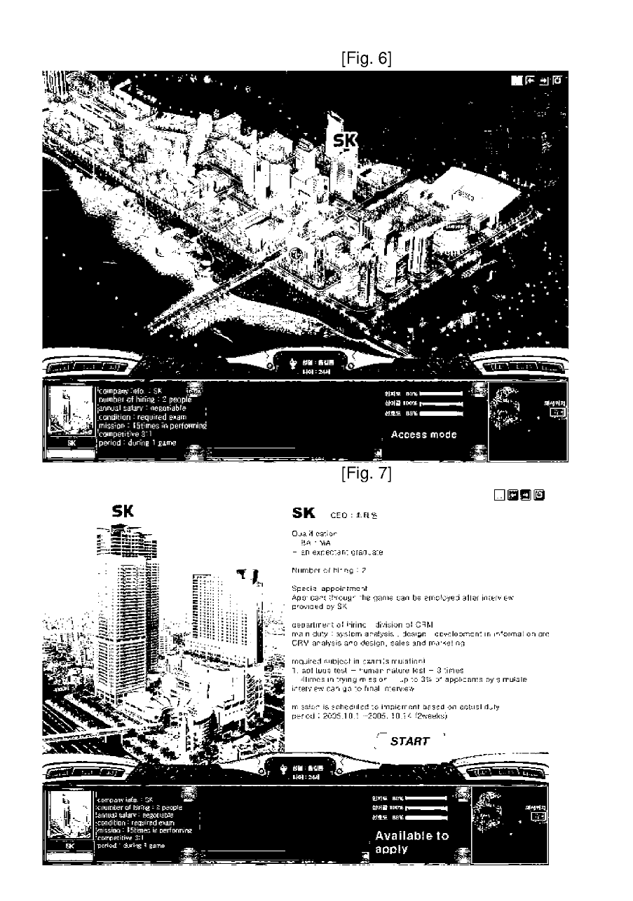

At this time, the list of companies displayed on the user terminal 100 may be generally in the form of text. Or, the list of companies, as shown in FIG. 6, may be displayed on the user terminal 100, with each company being moved into the virtual city and a logo, an advertisement, and a signboard of each company on the list being displayed on the building of each company in the virtual city. Also, a level of recognition, a level of bonus, a level of preference, and basic information for the corresponding company may be transmitted to the user terminal 100 according to a positional value for a mouse which is transmitted from the user terminal 100.

The user terminal 100 receives a selection value for a company with which the job applicant applies for a job among the list of companies and transmits the selection value to the game server 300 (S334). As shown in FIG. 6, the selection menu generating unit 320 of the game server 300 searches the database of the corresponding company, picks out a list of companies with a plan for employment and company information on the company selected by the user, and transmits the list and the company information to the user terminal 100 (S336).

At this time, the company information displayed on the user terminal 100 includes not only basic information on the company, such as a company name, a name of chief executive officer, a business registration number, a telephone number for inquiry about employment, and so forth, but also employment information, such as information on employment qualifications, a name of department with a plan for employment, the number of persons to be employed according to the department, the current number of applicants, the number of mission performances, an amount of time and a period taken to perform the mission, employment conditions, and so forth.

In another preferable embodiment of the present invention, as shown in FIG. 7, the basic information on the company and the information on the department which the job applicant applies for may be displayed on the graphic screen, along with an image of the building of the company which moves in the virtual city.

The user terminal 100 show the list of companies with a plan for employment to the job applicant, receives a selection value for the department from the job applicant, and transmits the selection value to the game server 300 (S338).

The selection menu generating unit 320 of the game server 300 outputs selection values for a type of company, a company, and a department, which are received from the user terminal 100, to the question/mission selecting unit 330. The question/mission selecting unit 330 searches the question/mission storing unit 417 of the member company database 410, selects the question/mission to be transmitted to the user terminal 100 according to the department selected by the job applicant, and transmits the selected question/mission to the user terminal 100 (S340). The question/mission storing unit 417 selects the question/mission without identification tag. i.e., the question/mission corresponding to a subject common to all departments, among the question/missions stored in the step S312, and the mission/question relating to the department indicated by the identification tag attached to the mission/question.

The user terminal 100 outputs the question/mission received from the game server 300 to the job applicant, receives an answer to the question/mission from the job applicant, and transmits a result of performing the question/mission to the game server 300 (S342). The step S342 is completed after the number of performing the question/mission reaches the specified number set by each of member companies.

At this time, the question/mission assigned to the job applicant includes the question/mission for evaluating basic job skills and qualifications necessary to perform the job of the department selected by the job applicant.

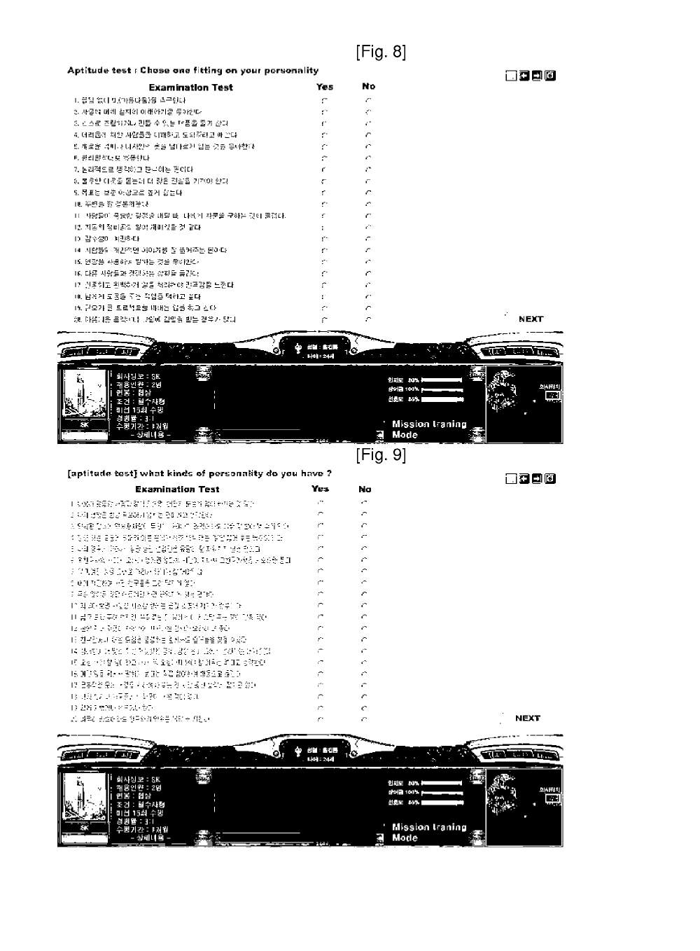

FIGS. 8 to 14 are examples showing a question/mission which is selected in the step S340 and performed at the user terminal in the step S340.

FIGS. 8 to 10 are examples showing a question/mission which each company commonly assigns to all job applicants irrespective of the department in need for employment. The question/mission includes an aptitude test, a character test, and a questionnaire about the job applicant's basic understanding of the culture of the company. The job applicant provides yes/no answers to the questions of FIGS. 8 to 10 displayed on the user terminal.

FIG. 11 is an example performing a question/mission relating to a corresponding group of job when the job applicant selects a specified group of job. FIG. 11 is an example showing that the user performs a task of guiding at the information desk. The performing of the specific task, like this, gives the job applicant opportunities to realize what job is assigned to him/her, and to determine if many hours of performing the specific task makes him/her sick and tired of it so that it is not suitable for his/her aptitude.

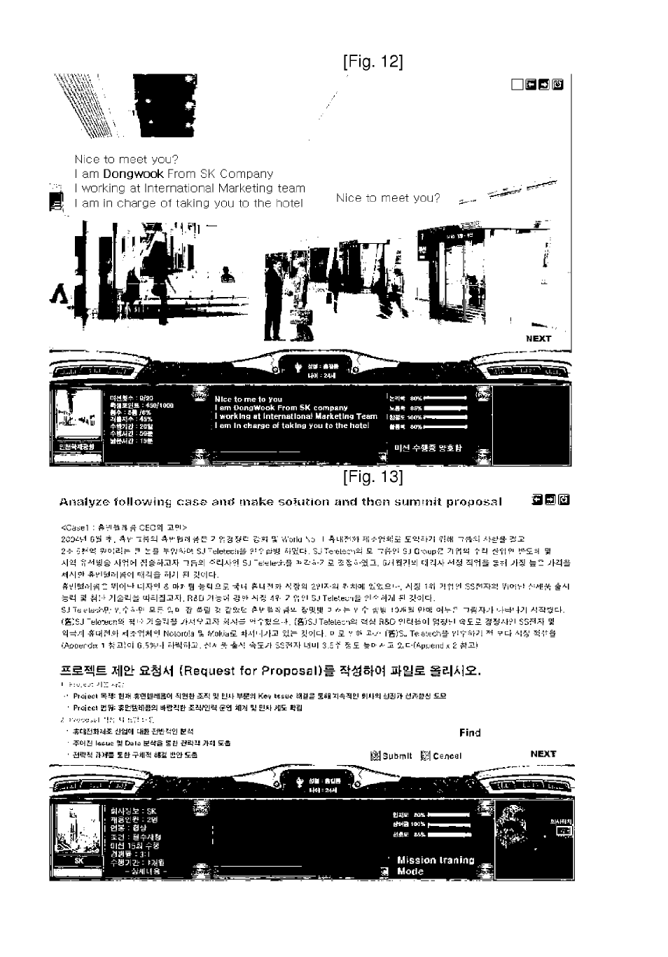

FIG. 12 is an example displaying on the screen a scenario or a simulation in which the job applicant meets a foreign buyer when the job applicant selects a department of overseas business. In the example, the job applicant may input conversation dialogue which, he/she thinks, is suitable for the situation through the user terminal 100. Thus, it is possible to test the job applicant's reasoning, responsiveness, thinking power, linguistic talents, and so forth.

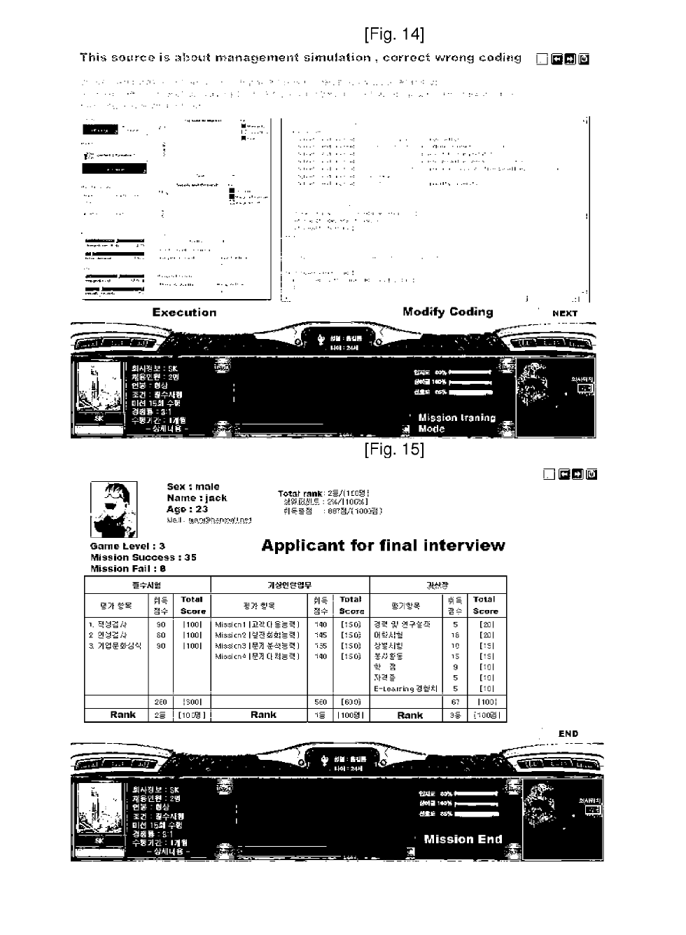

FIG. 13 is an example testing the job applicant's ability to analyze a problem. FIG. 14 is an example testing the job applicant's ability to deal with a problem. Especially, the job applicant may be assigned a mission of coding a given flowchart in a given computer native language, as well as a mission of correcting errors in given program source codes as shown in FIG. 14, when the job applicant selects a program development department with a mission of writing a software program.

The evaluating unit 340 of the game server 300, which receives a result of performing a question/mission from the user terminal 100, compares the result with the exemplary answer stored in the question/mission storing unit 417 to calculate a grade, and generates evaluation result data on the result of performing the question/mission (S350).

The evaluating unit 340 calculates a ranking according to a result of performing a question/mission in terms of each of departments which the job applicant applies for and calculates rankings of the job applicants in percentage terms. The evaluating unit 340 outputs the evaluation result data to the member database 450 of database server 400 and stores the evaluation result data in the information storing unit 455.

The evaluating unit 340 determines if the job applicant belongs to the specified high ranking (a range of the high ranking is within 3% in the preferable embodiment). The evaluation unit 340 transmits only the evaluation data to the user terminal to show the evaluation data to the job applicant, and the service for the job applicant according to the present invention again begins from the above described step S334 when the job applicant does not belong to the specified high ranking (S360).

The evaluating unit 340 transmits to the user terminal a notification that the user is selected as the final candidate for interview, along with the evaluation data (S362) and the user terminal outputs the evaluation data to the user when the job applicant belongs to the specified high ranking (S364). FIG. 15 is an example showing the evaluation data output to the user terminal.

Since then, the evaluating unit 340 inputs information on the job applicant (including the job applicant's selection value) to the interview question selecting unit 350. The interview question selecting unit 350 reads a mock interview question from the interview question storing unit 419 storing the mock interview question provided by each of member companies and transmits the mock interview question to the user terminal 100 (S370). The user terminal 100 receives an answer to the received mock interview question from the job applicant and transmits the answer to the game server 300 (S372). The interview question selecting unit 350 gives a grade to the received answer and transmits the grading result back to the user terminal 100 (S374). The user terminal 100 shows the grading result to the job applicant. The step S370 to S376 may be omitted in other embodiments of the present invention.

The evaluating unit 340 transmits to the member company server 200 a list of high ranked job applicants who belong to the specified high ranking, along with the personal information, personal history information, and evaluation information on each of the high ranked job applicants and provides to each of member companies (a list of) talented applicants who have excellent records in performing the question/mission in terms of the requirement of each member company (S380). The member company sever 200 receives and stores the list of high ranked applicants to make use of the list in employing a talented person (S382).

The above-described preferable embodiments are about the job applicant who is not employed. However, the method and the system for playing a game helping get a job according to the present invention may be also in use for evaluating an aptitude and a business skill of a new employee whom entrance into the company is granted to and for posting each of the new employees to the department that is suitable for each of them.

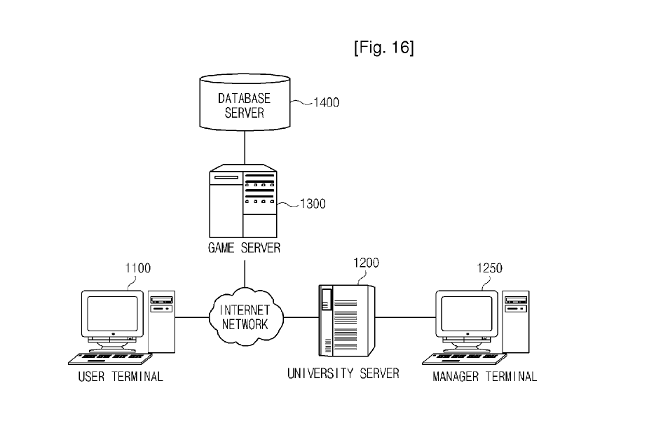

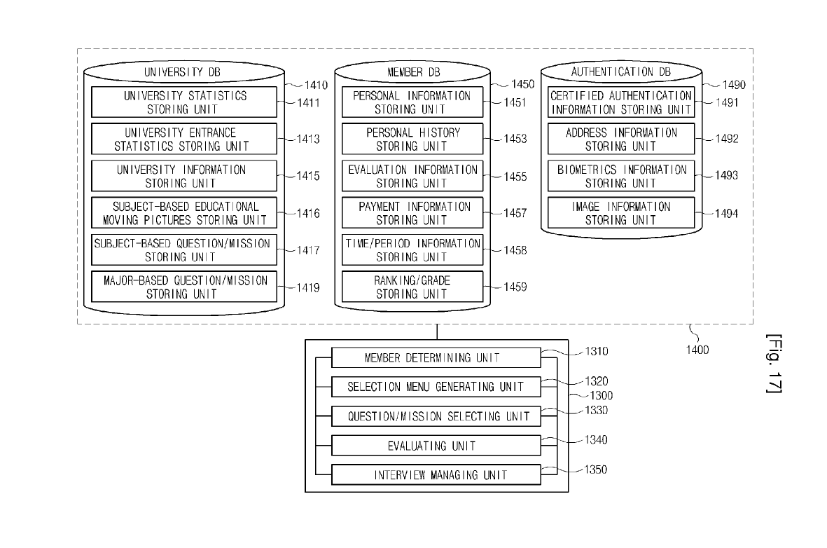

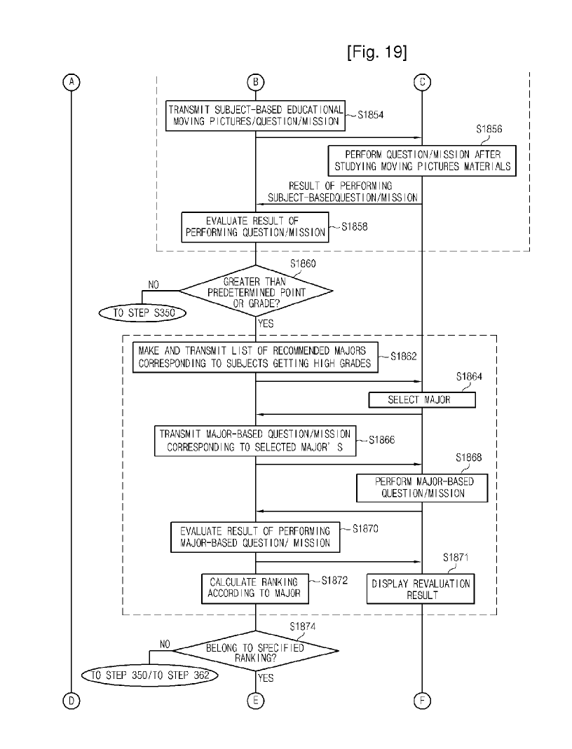

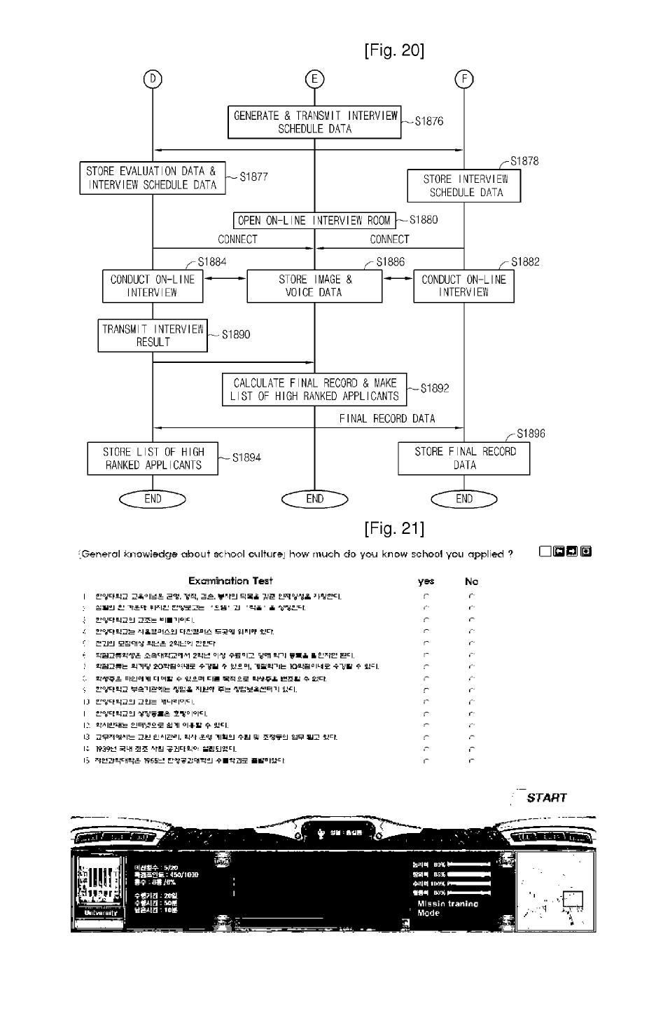

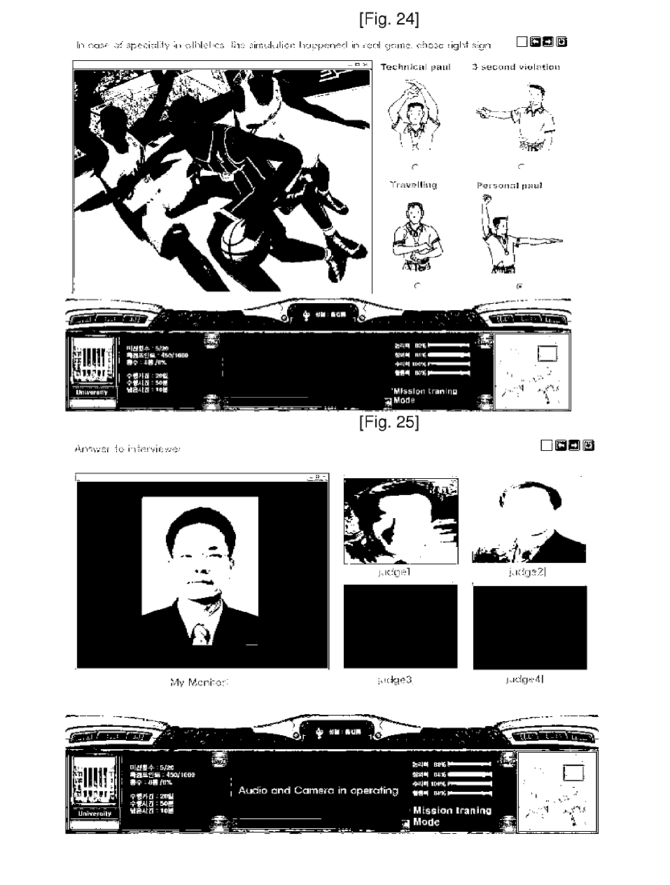

Referring to FIGS. 16 to 25, a method and a system for playing a game helping enter into a university or a school of higher grade will be now described. FIG. 16 is a block diagram showing a configuration of a system for playing a game helping enter into a university or a school of higher grade according to one preferable embodiment of the present invention. Referring to FIG. 16, there is provided a system for playing a game helping enter into a university or a school of higher grade, including a game server 1300, a database server 1400 working in association with the game server 1300, a user terminal 1100, a university server 1200, and a manager terminal 1250 connected to the university terminal 1200 over a short-distance telecommunication network.

A image capturing means such as an WEB camera and a microphone may be provided to the user terminal 1100 and the manager terminal 1250 to make possible a motion picture chatting.

The database server 1400 includes a university database 1410, a member database 1450, and an authentication database 1490. The university database 1410 stores information on a university including basic information on the university and statistical information on the university and a question/mission provided by the university. The member database 1450 stores personal information, personal history information, evaluation information, and payment information on an applicant who wants to enter into a university or a school of higher grade. The authentication database 1490 prevents other people other than a legitimate applicant from playing the on-line game and prevents the individual information on the applicant playing the on-line game from being leaked.

The game server 1300 grants registration and entrance of a university and a member, transmits to the user terminal 1100 the question/mission stored in the database server 1400 according to the applicant's selection value, provides the question/mission to the applicant, and transmits to the university server 1200 a list of high ranked applicants who belong to a specified high ranking as a result of performing the question/mission among the applicants.

The university server 1200 provides the information on the university and the question/mission provided by the university to the game server 1300 and receives from the game server 1300 the list of high ranked applicants who belong to the specified high ranking as a result of evaluating a result of performing the question/mission, along with personal information and personal history information on each of the high ranked applicants.

The user terminal 1100 selects the university which an applicant wants to enter into and a department of the university in response to the user's operation, and transmits to the game server 1300 the result of performing the question/mission received from the game server 1300.

FIG. 17 is a block diagram showing in detail configurations of the game server 1300 and the database server 1400 as shown in FIG. 16. Referring to FIG. 17, the database server 1400 includes the university database 1410, the member database 1450, and the authentication database 1490.

The university database 1410 includes a university statistics storing unit 1411, a university-entrance statistics storing unit 1413, a university information storing unit 1415, a subject-based question/mission storing unit 1417, and a major-based question/mission storing unit 1419.

The university statistics storing unit 1411 stores statistical information on the university that is announced every year, such as a level of recognition, a level of preference, and a percentage of employment. The university-entrance statistics storing unit 1413 stores statistical information on university entrance according to the university, such as the number of applicants who apply for admission to a university every year, the approved number of freshmen, a percentage of admission competition, high-school examination records of freshmen, freshmen's averaged records of the learning competence examination, distribution of the high schools from which freshmen graduated, a percentage of on-line/off-line admission competition, and so forth.

The university information storing unit 1415 stores basic information on the university, such as a university name, a president name, a founder name, information on colleges of the university, and information on departments of the colleges.

A subject-based educational moving pictures storing unit 1416 stores subject-based educational moving pictures received directly from the university server 1200. A subject-based question/mission storing unit 1417 stores a question/mission which is prepared based on the scope of educational moving pictures.

A major-based question/mission storing unit 1419 stores a major-based question/mission selected by a user.

The member database 1450 includes personal information storing unit 1451 storing individual information on the member, personal history information storing unit 1453 storing personal history information on the member, evaluation information storing unit 1455 storing data on evaluation of a result of performing the method for playing the on-line game helping enter into a university or a school of higher grade according to the present invention, such as grades in the result of performing the question/mission based on the department which an applicant applies for, a standing of an applicant, and a ranking of an applicant in percentage terms, a payment information storing unit 1457 storing payment information on a member, a time/period information storing unit 1458 storing an amount of time and a period taken to perform the question/mission, and a ranking/grade information storing unit 1459 storing a ranking-based grade corresponding to the ranking which the member obtained as a result of performing an individual mission or a whole mission.

The authentication database 1490 includes a certified authentication information storing unit 1491, an address information storing unit 1492, a biometrics information storing unit 1493, and an image information storing unit 1494.

The authentication information storing unit 1491 stores authentication information such as a certificate of authentication issued by the Financial Supervisory Commission or a bank. The address information storing unit 1492 stores information making it possible to identify the user terminal, such as the user terminal's IP (Internet Protocol) address or MAC (Media Access Control) address.

The biometrics information storing unit 1493 stores fingerprint recognition information, iris recognition information, and gene recognition on a user to be used in a living body recognition device, such as a fingerprint recognition mouse, installed in the user terminal.

The image information storing unit 1494 stores moving pictures taken by an image capturing means installed in the user terminal to prevent an improper act, showing an actual situation where a user answers the question, and performs the mission. The image information storing unit 1494 stores data on moving pictures showing that the user conducts an on-line motion pictures interview.

The game server 1300 includes a member determining unit 1310, a selection menu generating unit 1320, a question/mission selecting unit 1330, an evaluating unit 1340 and an interview managing unit 1350.

The member determining unit 1310 receives the basic university information, the university-entrance statistics information, and the basic university-entrance information from a university which applies for membership, determines if the university is registered as a member university according to a specified regulation. The member determining unit 310 also receives the personal information, the personal history information and the payment information on the applicant from the user terminal 100, and determines if the applicant is registered as a member according to a specified regulation.

The selection menu generating unit 1320 searches the university database 1410, generates a university-entrance type of the applicant, a type of the university which the applicant applies for admission to, a list of universities which belong to the type of the selected university, and a list of departments of the selected university which invites freshmen, transmits the university-entrance type, the type of the university, the list of university, and the list of departments to the user terminal 100, and receives a selection value.

In addition, the selection menu generating unit 1320 generates a menu for university-entrance type, a menu for university type, a list of universities, a list of subjects, and a list of recommended majors to transmit them to the user terminal 1100.

The question/mission selecting unit 1330 searches the subject-based question/mission storing unit 1417 and the major-based question/mission storing unit 1419 of the university database 1410 according to the selection value received from the user terminal 1100, selects the question/mission corresponding to the department of the university which the applicant selects, and transmit the question/mission to the user terminal 1100.

The evaluating unit 1340 receives answer information on the question/mission received from the user terminal 1100, compares the answer information with an exemplary answer stored in the subject-based question/mission storing unit 1417 and the major-based question/mission storing unit 1419 to calculate a grade, and evaluates a result of performing the question/mission.

The interview managing unit 1350 schedules an on-line interview between the applicants who belongs to the specified high ranking as a result of performing the question/mission and an interviewer of the university which the applicant applies for admission to, opens an image room for on-line interview over the Internet at a designated date and time. The interview managing unit receives image and voice data on the applicant from the user terminal 1100 connecting to the image room for on-line interview, stores the image and voice data in the image information storing unit 1494, and, at the same time, transmits the image and voice data to the manager terminal 1250 connecting to the image room for on-line interview. The interview managing unit 1350 receives the image and voice data from the manager terminal 1250, stores the image and voice data in the image information storing unit 1494, and at the same time, transmits the image and voice data to the user terminal 1100.

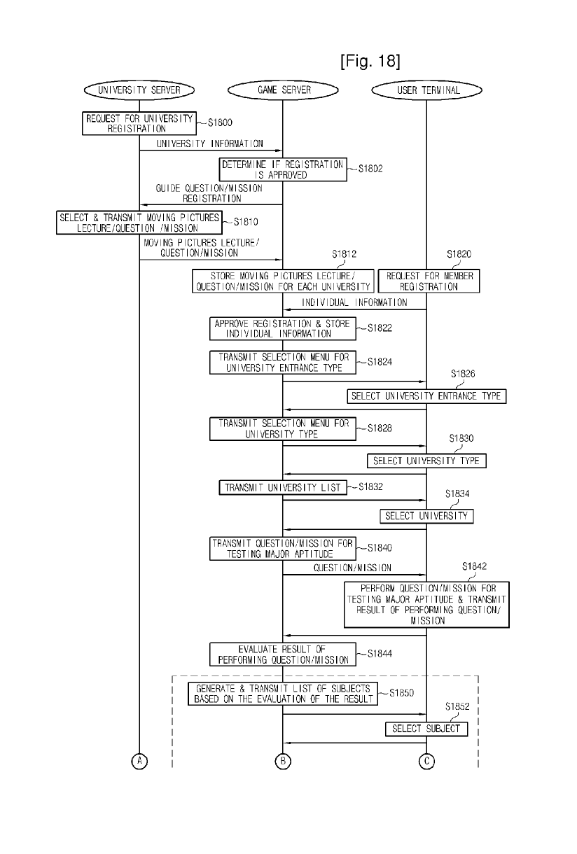

FIGS. 18 to 20 are flowcharts explaining one preferable embodiment of a method for playing a game helping enter into a university or a school of higher grade according to the present invention. Referring to FIGS. 18 to 20, a method for playing a game helping entering into a university of a school of higher grade is now described. A university server 1200 of a university connects to a game server 1300 of the present invention over the Internet, selects a university member registration menu from a main menu displayed on an WEB page which the game server 1300 displays on the university server 1200, requests the game server 1300 for register of the university as a member, and transmits to the game server 1300 basic university information requested by the game server 1300 (S1800).

The university information includes basic university information, university-entrance statistics information, basic university-entrance information, and so forth on a university requesting for registration. The basic university includes a foundation year, a location, the number of students, information on colleges belonging to the university, information on departments belonging to the college, curriculum information on each department, and the approved number of freshmen based on the department.

The university-entrance statistics information includes the past approved numbers of admission of applicants, the number of applicants who applied for admission to each university, a percentage of university-entrance competition, and so forth. The basic university-entrance information includes admission qualifications, a form of admission application, and so forth which are necessary when a university invites freshmen on-line or off-line. The admission qualifications include information on an academic background, a career record, school records, proficiency in foreign language, a certificate of qualifications, reward and punishment, a certificate of a person of merit, and a certificate of disabled person.

The member determining unit 1310 of the game server 1300 receives the university information from the university server 200, determines if an application for registration of a member university is approved according to a specific regulation, and transmits to the university server 1200 an WEB page showing how to register the question/mission when the application for registration of a member university is approved (S1802).

The university server 1200 receives approval information and transmits information on the question/mission to be provided to the applicant to the game server 300 (S1810). The question/mission may be in the form of a multiple selection test, a scenario, or a simulation. Each question/mission may be selected according to a variety of university-learning skills to test the variety of university-learning skills, such as an ability to converse well with someone, an ability to analyze a problem, an ability to deal with a situation, an ability to reason, originality, an ability to speak in foreign language, and so forth. The university server 200 may attach to each question/mission an identification tag indicating if the question/mission is related to common liberal arts, or if the question/mission is assigned to an applicant applying for a specific department.

The game server 1300 outputs the received question/mission to the university database 1410 of the database server 1400, and the university database 1410 stores the received question/mission in the subject-based question/mission storing unit 1417 and the major-based question/mission storing unit 1419 among storing areas of the university (S1812).

There is provided another embodiment of a method for playing an on-ling game helping enter into a university or a school of higher grade according to present invention. As in the embodiment of the method for playing a game helping get a job, the method, as shown in FIG. 5, serves to stir up interest in playing the game, including building a virtual city in a three-dimensional space and allowing a university to build a virtual campus by renting a certain space from the virtual city after paying a certain rent, or to buy an existing building after paying a charge, in the step S 1800.

In the step S1832, which will be described later, a screen image, where an appearance of the building which the university selected in the step S1800 displays along with a logo of the university, may be transmitted to the user terminal 1100. In the step S1834, the selection of the building of the university in the virtual city by the user may make it possible to select the university. Thus, these not only give the university an advertising benefit, but also motivate the applicant to have interest in playing the game.

As in the above described method for playing a game helping get a job, referring to FIG. 5, buildings available for sale may be displayed on the screen when the member university displays a building purchase page in order to buy a building in the existing virtual city, and the price of the building may be displayed when the member university selects one building among the buildings displayed on the screen. In a case where a building site is to be purchased, the building site transaction terms displayed on the screen is similar to the building transaction terms displayed on the screen. When one building available for sale is selected, detailed information on the building, such as a use of the building, a price of the building and a payment method, may be displayed on one portion of the screen. Transaction Information indicating whether or not the building or the building site is still available for sale may be displayed on other portion of the screen to avoid a double transaction among the member universities.

When the applicant connects to the game server 1300 over the Internet using the user terminal 1100, the game server 1300 displays the main WEB page on the user terminal 1100 and the applicant inputs individual information requested by the game server 1300, transmits the individual information to the game server 1300 and requests for registration (S1820). The individual information on the applicant includes not only personal information such as a name, a resident registration number, a telephone number, and a home address, but also a personal history information and payment information necessary to make payment of a charge for using the service provided by the present invention.

The member determining unit 1310 of the game server 1300 receives the individual personal information from the user terminal 1100, determines if the applicant is registered as a member according to a specified regulation, and outputs the individual information to the member database 1450 when it is determined to register the applicant as the member. After classifying the individual information into the personal information, the personal history information, and the payment information, the member database 1450 stores the personal information, the personal history information, and the payment information in the personal information storing unit 1451, the personal history storing unit 1453, and the payment information storing unit 1457, respectively (S1822).

The selection menu generating unit 1320 of the game server 1300 transmits the selection menu for selecting a university-entrance type to the user terminal 1100 when a member registration is completed (S1824). The user terminal 1100 receives a selection value for the university-entrance type on the menu and transits the selection value to the game server 1300 (S1826). The university-entrance type is classified into general at-any-time selection, selection for workers, selection for talented students, selection for graduates from a trade school, selection through recommendation of a principal of high school, selection for students from farming and fishing communities, selection for students in need of special education, selection for children of overseas Korean, selection for boys and girls as head of household, and so forth.

The selection menu generating unit 1320 searches the university database 1410 for a university with a plan for student invitation according to a type of university-entrance, reads the university with the plan for student invitation and transmits a selection menu for selecting a type of university to the user terminal 1100 to display the selection menu (S1828). The selection menu for selecting a type of university is a primary classification of universities according to the type of a university which an applicant, i.e., a member wants to enter into. The selection menu for selecting the type of company includes a four-year general university community, a two-year college community, a credit bank community, and a special university (including the Military Academy, Korea National Police University, and Korea Advanced Institute of Science and Technology).

The user terminal 1100 receives a selection value for the type of university on the menu and transmits the selection value to the game sever 1300 (S1830). The selection menu generating unit 1320 of the game server 1300 displays a list of universities corresponding to the selected type of university to the user terminal 1100 (S1832).

At this time, the list of universities displayed on the user terminal 1100 may be generally in the form of text. Alternatively, as in the method for playing the on-line game helping get a job, which is described referring to FIGS. 6 and 7, the list of universities may be displayed on the user terminal 1100, with each university being moved into the virtual city and a logo, an advertisement, and a signboard of each university on the list being displayed on the campus of each university in the virtual city. Also, a level of recognition, the approved number of new students, a level of preference, and basic information for the corresponding university may be transmitted to the user terminal 1100 according to a positional value for a mouse which is transmitted from the user terminal 1100.

The user terminal 1100 receives a selection value for a university which the applicant wants to enter into among the list of universities and transmits the selection value to the game server 1300 (S1834). The question/mission selecting unit 1330 of the game server 1300 reads a question/mission for testing an aptitude for major from the subject-based question/mission storing unit 1417 of the university selected by the applicant registered in the university database 1410 and transmit the question/mission for testing an aptitude for major to the user terminal 1100 (S1840). The applicant performs the question/mission for testing an-aptitude for major displayed on the user terminal 1100 and transmits a result of performing the question/mission to the game server (S1842).

The question/mission for testing an aptitude for major consists of a variety of test items for testing originality, mathematical ability, and character, which help select the department suitable for the applicant based on the test result. Quite similar to the way that the method for playing the on-line game helping get a job is above described referring to FIGS. 8 and 9, the question/mission for testing an aptitude for major may be in the form of a yes/no question test, or a multiple selection test, or an argumentative essay examination requiring a personal opinion on how to deal with a given situation.

The evaluating unit 1340 of the game server 1300 evaluates the result of performing the question/mission for testing an aptitude for major and generates an evaluation result data (S1844). At this time, the aptitude for major which the applicant can select may be largely divided into an aptitude for a college of liberal arts and an aptitude for a college of science according to the evaluation result. The college of science is subdivided into colleges of engineering, science, medical science and so forth. The college of liberal arts is subdivided into colleges of literature, law, business management, and so forth. One major field for study may be selected by the applicant according to the evaluation result. However, several major fields for the applicant may be selected according to the applicant's aptitude.

The selection menu generating unit 1320 generates a list of subjects corresponding to a major field for study suitable for the applicant according to the evaluation result input from the evaluating unit 1340 and transmits the list of subjects (S1850). The list of subjects may include a list of compulsory subjects necessary for a major field of study suitable for the applicant based on the evaluation result. For example, the list of compulsory subjects including differential and integral calculus, physics, and so forth is transmitted to the user terminal 110 in a case where the major field of study suitable for the applicant is determined as engineering.

The applicant selects one subject among the list of subjects displayed on the user terminal 110 and transmits the one subject to the game server 1300 (S1852). The question/mission selecting unit 1330 of the game server 1300 reads a stored educational moving pictures data and a stored question/mission data from the subject-based question/mission storing unit 1417 according to the selected subject and transmits the stored educational moving pictures data and the stored question/mission data to the user terminal 1100 (S1854).

The user terminal 1100 displays to the applicant the moving pictures received from the game server 1300. The user terminal 1100 displays to the applicant the question/mission which is associated with contents corresponding to the moving pictures and transmits a result of performing the question/mission to the game server 1300 after the applicant performs the question/mission (S1856).

The evaluating unit 1340 compares data on evaluation of the result of performing the question/mission received from the user terminal 1100 with exemplary data stored in the subject-based question/mission storing unit 1417, and evaluates the result of the applicant's performing the question/mission (S1858).

The above described steps S1850 to S1858 are applied to a plurality of subjects. The evaluating unit 1340 checks if there is any subject for which the applicant got the point or grade greater than the predetermined point or grade(S1860). The evaluating unit 1340 performs the steps S1850 to S1858 again in the absence of the subject for which the applicant got the point or grade greater than the predetermined point or grade, and generates a recommended list of major subjects corresponding to the subjects for which the applicant got the point or grade greater than the predetermined point or grade and transmits the recommended list to the user terminal 1100(S1862).

The user terminal 1100 selects one subject among the recommended list of major subjects and transmits the one subject to the game server (S1864). The question/mission generating unit 1330 reads a question/mission data corresponding to the major field of study selected by the applicant from the question/mission storing unit 1419 and transmits the question/mission data to the user terminal 1100 (S1866).

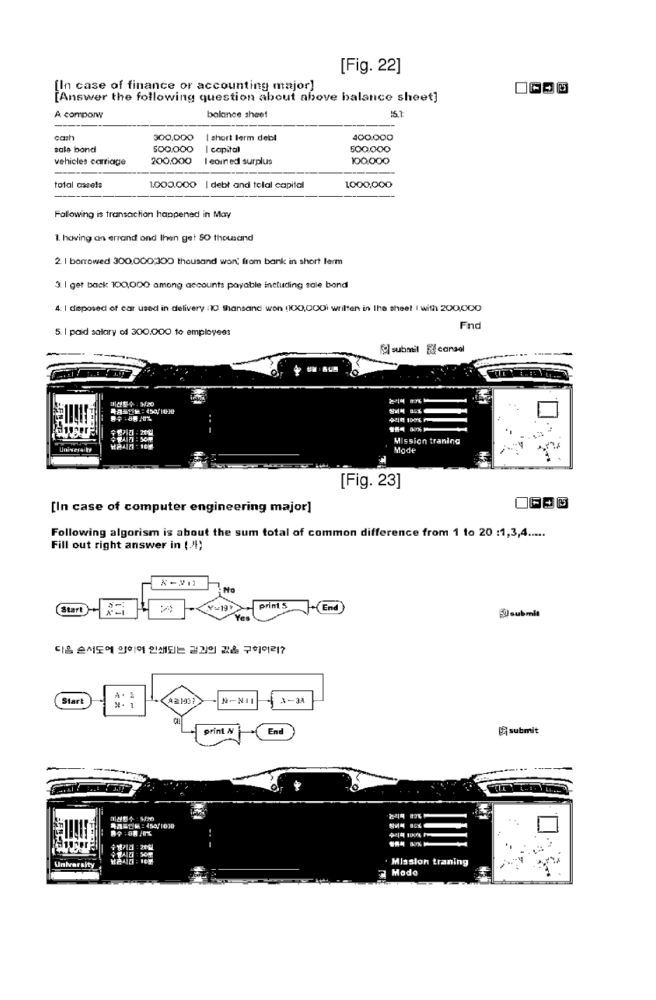

FIG. 22 to FIG. 24 are examples showing the question/mission selected based on the major field of study. For example, FIG. 22 is an example showing the question/mission provided to the applicant who selects his/her major field of study as business management or accounting. FIG. 23 is an example showing the question/mission provided to the applicant who selects his/her major field of study as computer engineering or electronics. FIG. 24 is an example showing the question/mission provided to the applicant who selects his/her major field of study as physical education.

A question/mission similar to that illustrated in FIG. 13 concerning the method for playing the on-line game helping get a job may be provided to the applicant who selects his/her major field of study as business management or politics. A question/mission similar to that illustrated in FIG. 14 concerning the method for playing the on-line game helping get a job may be provided to the applicant who selects his/her major field of study as computer engineering or management information engineering.

The user terminal 1100 displays the received major-based question/mission data to the applicant and transmits a result of performing the question/mission input from the applicant to the game server 1300 (S1868). The evaluation unit 1340 compares data on evaluation of the result of performing the question/mission, which is received from the user terminal 1100, with corresponding exemplary answer data stored in the major-based question/mission storing unit 1419, and evaluates the result of the applicant's performing the question/mission. The evaluation unit 1340 then stores the evaluation result to the ranking/grade information storing unit 1459 and transmits the evaluation result to the user terminal 1100 (S1870). The user terminal 1100 displays the revaluation result data received from the gamer server 1300 to the applicant (S1871).

The evaluating unit 1340 of the game server 1300 calculates a ranking of the applicant based on the corresponding major field of study and stores the ranking of the applicant in the ranking/grade information storing unit 1459 of the member database 1450 (S1872). The evaluating unit 1340 determines if the applicant belongs to the specified high ranking (S1874). The service for the applicant goes back to the above described step S1850 and again begins from the step S1850 when the applicant does not belong to the specified high ranking. Or, the service goes back to the above described step S1862 and repeatedly begins from the step S1862 through the step S1872.

The interview managing unit 1350 of the game server 1300 generates an interview schedule data and transmits the interview schedule data to the user terminal 1100 when in the step S1874 the applicant belongs to the specified ranking in terms of the major field of study selected by the applicant according to the result of performing the question/mission. The interview managing unit 1350 transmits evaluation data and the interview schedule data on the applicant who is required to have the interview, to the university server 1200 (S1876). The user terminal 1100 stores the received interview schedule data (S1877). The university server 1200 stores the received evaluation data and interview schedule data on the applicant required to have the interview (S1878).

The manager terminal 1250 connects to an on-line interview room through the university server 1200 and the user terminal 1110 connects to the on-line interview room over the Internet when the interview managing unit 1350 of the game server 1300 opens the on-line interview room over the Internet on a designated interview data (S1880).

The manager terminal 1250 transmits to the game server 1300 voice data and image data on a picture of an interviewer taken by an image capturing means installed in the manager terminal 1250, such as an WEB camera, during the time of conducting the interview. The user terminal 1100 transmits to the game server 1300 voice data and image data on a picture of the applicant taken by the image capturing means installed in the user terminal 1100, such as the WEB camera, thus conducting the on-line interview (S1882, S1884). The interview managing unit 1350 stores the voice data and image data received from the user terminal 1100 and the manager terminal 1250 in the image information storing unit 1494 and transmits the voice data and the image data to the manager terminal 1250 and the user terminal 1100, thus making it possible to realize the on-line interview (S1886).

FIG. 24 is an example showing the conducting of the on-line interview from the step S1882 through the step S1886. As shown in FIG. 24, a face of the applicant using the user terminal 1100 and a face of the interviewer conducting the on-line interview using the manager terminal 1250 display on one screen. A voice of the applicant and a voice of the interviewer are output through speakers installed in the user terminal 1100 and the manager terminal 1250, respectively.

The interviewer transmits an interview result data to the game server 1300 including an interview grade obtained by the applicant to the gamer server 1300 through the manager terminal 1250. The game server 1300 calculates a final evaluation result by adding the interview result and the result of evaluating the result of performing the question/mission selected by the applicant and generates a list of high ranked applicants according to the major field of study. The game server 1300 transmits the list of high ranked applicants according to the major field of study to the university server 1200, and transmits the final record data reflecting the on-line interview result obtained by the applicant to the user terminal 1100 (S1892).

The list of high ranked applicants according to the major field of study, which is received from the game server 1300, is stored in the university server 1200 and is used for inviting a new student (S1894). The received final record data is stored in the user terminal 1100 (S1896).

The invention can also be embodied as computer readable codes on a computer-readable recording medium. The computer readable recording medium is any data storage device that can store data which can be thereafter read by a computer system. Examples of the computer-readable recording medium include read-only memory (ROM), random access memory (ROM), CD-ROMs, a magnetic tape, floppy disks, optical data storing device, carrier waves (such as data transmission over the Internet). The computer-readable recording media can also be distributed over network coupled computer systems in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for playing a game helping get a job, comprising steps of:
(a) allowing a game server to receive a selection value for a company which a user wants to apply for a job with and a department of the company from a user terminal;
(b) allowing the game server to read a question/mission stored in connection with the company and the department represented by the selection value from a database server which works in association with the game server, and to transmit the question/mission to the user terminal;
(c) allowing the game server to receive a result of performing the question/mission from the user terminal, to compare the result with an exemplary answer to the question/mission read from the database server, and to generate data on evaluation of the result of performing the question/mission; and
(d) allowing the game server to calculate a ranking of the user according to the data on evaluation of the result, and transmit information on a user who belongs to a given ranking to a member company server which provides the question/mission.

2. The method according to claim 1, further comprising, before the step (a), a step of allowing the game server to receive information on the company and the question/mission relating to the company from the member company server, and to store the information and the question/mission in the database server.

3. The method according to claim 1, further comprises, before the step (a), a step of allowing the game server to transmit an image where a logo of each of the companies are shown on buildings to the user terminal, wherein in the step (a), the game server is allowed to receive the selection value for each of the buildings.

4. The method according to claim 1, wherein the step (a) comprises steps of:
allowing the game server to transmit a first selection menu for selecting a type of employment and a type of company to the user terminal and to receive a first selection value for the first selection menu; and
allowing the game server to read a list of companies and a list of department of each of the companies from the database server according to the first selection value, to transmit the list of companies and the list of departments, and to receive a second selection value for the list of companies and the list of department from the user terminal.

5. The method according to claim 1, wherein, in the step (d), the information on the user includes personal information on the user, personal history information on the user, and the data on evaluation of the result.

6. The method according to claim 1, wherein the step (d) comprises a step of allowing the game server to transmit mock interview question data on a company represented by the selection value to the user terminal of the user who belongs to the given ranking.

7. A computer-readable medium having embodied thereon a computer program for the method according to any one of claims 1 to 6.

8. A system for playing a game helping get a job, comprising:
a database server storing information on a member company including basic information and statistical information on the company, a question/mission provided by the member company, personal information on a user, personal history information on the user, evaluation information and payment information;
a game server transmitting the information on the member company and the question/mission to the user terminal according to a user's selection value, comparing a result of performing the question/mission with an exemplary answer to the question/mission stored in the database server, generating data on evaluation of the result, generating a list of high ranked users who belong to a specified ranking according to the evaluation of the result, and transmitting the list of high ranked users;
a member company server transmitting the information on the member company and the question/mission to the game server, storing the information on the member company and the question/mission in the database server, and receiving the list of high ranked users; and
a user terminal receiving a selection value representing a company in need for employment and a department of the company in response to the user's operation, transmitting the value to the game server, and transmitting to the game server the result of performing the question/mission received from the game server.

9. The system according to claim 8, wherein the game server comprises:
a question/mission selecting unit searching the database server, generating at least one among a type of employment which the user looks for, a type of a company which the user applies for a job with, a list of companies which belong to a type of a selected company and a list of departments of the selected company which are in need for employment, transmitting the at least one to the user terminal, and receiving the selection value from the user terminal;
a question/mission selecting unit searching the database server according to the selection value, selecting a question/mission corresponding to a department of a company which the user selects, and transmitting the question/mission to the user terminal; and
an evaluating unit receiving answer information on the question/mission received from the user terminal, comparing the answer information with an exemplary answer read from the database server to calculate a grade, and generating data on evaluation of the result of performing the question/mission.

10. The system according to claim 8, wherein the database server comprises;
a company statistics storing unit storing statistical information on the company including at least one among a level of recognition, a level of preference, and a level of annual salary;
an employment statistics storing unit storing statistical information on employment for the company including at least one among the number of applicants on a yearly basis, the number of recruited employees, a percentage of employment competition, school records of applicants, applicants' averaged records of foreign language proficiency test, distribution of schools from which applicants graduated, and a percentage of on-line/off-line employment competition;
a company information storing unit storing basic information on the company such as a company name, a name of chief executive officer, a business registration number, basic information on financial status; and
a question/mission storing unit storing the question/mission provided by the member company server according to a department.

11. The system according to claim 10, wherein the database server further comprises an interview question storing unit storing an anticipated question for a mock interview to be transmitted to the user terminal corresponding to the list of high ranked users.

12. The system according to claim 8, wherein the database server comprises an authentication information database which is used in verifying if the user is a legitimate gamer, the authentication information database comprising at least one among:
a certified authentication information unit storing certified authentication information issued by the Financial Supervisory Commission or a bank;
an address information storing unit storing at least one among the user terminal's IP (Internet Protocol) address and MAC (Media Access Control) address which make it possible to identify the user terminal; and
a biometrics information storing unit storing the user's biometrics information.

13. A system for playing a game helping get a job, which connects to a member company server, a user terminal, and a database server over telecommunication network, comprising:
a selection menu generation unit searching the database server, generating at least one among a type of employment which a user looks for, a type of a company which the user applies for a job with, a list of companies which belong to a list of companies which belong to a type of a selected company and a list of departments of the selected company which are in need for employment, transmitting the at least one to a user terminal, and receiving a selection value from the user terminal;
a question/mission selecting unit searching the database server, selecting a question/mission corresponding to a department of a company which is selected by the user, and transmitting the question/mission to the user terminal; and
an evaluating unit receiving an answer information on the question/mission received from the user terminal, comparing the answer information with an exemplary answer read from the database server to generate a grade, and generating data on evaluation of the result of performing the question/mission.

14. A method for playing a game helping enter into a university or a school of higher grade, comprising steps of:
(a) allowing a game server to receive university selection information from a user terminal operated by an applicant who wants to enter into a university or a school of higher grade, to make a list of subjects suitable for an aptitude of the applicant among a list of subjects stored, in connection with a university represented by the selection information, in a database server which works in association with the game server, to transmit the list of suitable subjects to the user terminal, and to receive a value for at least one or more subjects;
(b) allowing the game server to read educational moving pictures data and a question/mission data on the selected subject from the database server, to transmit the educational moving pictures data and the question/mission data to the user terminal, to receive first data on a result of performing the question/mission from the user terminal, and to generate first data on evaluation of the result;
(c) allowing the game server to read major-based question/mission data corresponding to a selected major from the database server and to transmit the major-based question/mission to the user terminal when the game server selects a list of recommended majors corresponding to subjects which get grades exceeding a specified grade based on the first data on evaluation of the result, transmits the list of recommended majors, and receives major selection information from the user terminal; and
(d) allowing the game sever to receive second data on a result of performing the major-based question/mission from the user terminal, to generate second data on evaluation of the result, to generate ranking information on the applicant in terms of the major according to the second data on evaluation of the result, and to transmit the ranking information on the applicant to a university server which provides the major-based question/mission data.

15. The method according to claim 14, further comprising, before the step (a), steps of:
allowing the game server to transmit a menu for selecting a type of entrance into a university and a type of a university to the user terminal and to receive selection information on the type of entrance into a university and the type of a university from the user terminal; and
allowing the game server to transmit a list of universities corresponding to the selected type of entrance into a university and the selected type of a university and to receive selection information on the selected type of entrance into a university and the selected type of a university from the user terminal.

16. The method according to claim 14, wherein the step (a) comprises steps of:
(a1) allowing the game server to receive the university selection information from the user terminal, to read a question/mission for testing an aptitude for major, which is stored in connection with the selected university, from the database server, and to transmit the question/mission for testing an aptitude for major to the user terminal;
(a2) allowing the game server to receive third data on a result of performing the question/mission for testing an aptitude for major and to generate third data on evaluation of the result of performing the question/mission; and
(a3) allowing the game server to make a list of subjects corresponding to a type of major suitable for the applicant according to the third data on evaluation of the result and to receive a selection value for at least one or more subjects from the user terminal.

17. The method according to claim 14, wherein the step (d) comprises steps of:
(d1) allowing the game server to receive data on the result of performing the major-based question/mission from the user terminal and to generate the second data on evaluation of the result;
(d2) allowing applicants, who belong to a specified ranking based on the second data on evaluation of the result, to conduct an on-line moving pictures interview, among applicants who applies for the same major; and
(d3) allowing the game server to receive data on evaluation of a result of conducting the on-line moving pictures interview from a manager server which works in association with the university server, to make a list of high ranked applicants base on the second data on evaluation of the result of performing the major-based question/mission and the data on evaluation of a result of conducting the on-line moving pictures interview, and to transmit the list of high ranked applicants to the university server.

18. The method according to claim 17, wherein the step (d2) comprises steps of:
allowing the game server to open an on-line interview room;
transmitting image and voice data on the applicant and image and voice data on an interviewer received from the user terminal and the manager terminal which are connecting to the on-line interview room to the manager terminal and the user terminal, respectively; and
storing the image and voice data on the applicant and the interviewer received from the user terminal and the manager terminal in the database server.

19. The method according to claim 14, wherein the steps (a) and (b) are performed again when the subjects getting grades exceeding a specified grade based on the first data do not exist in the step (c).

20. A computer-readable medium having embodied thereon a computer program for the method according to any one of claims 14 to 19.

21. A system for playing a game helping enter into a university or a school of higher grade, comprising:
a database server storing university information on a university including basic information and statistical on the university, subject-based question/mission data, and major-based question/mission data, which are received from the university server, and personal information, personal history information, evaluation information and payment information which are on an applicant who want to enter into a university or a school of higher grade; and
a game server transmitting the university information and the question/mission data to a user terminal according to a selection value received from the user terminal of the applicant, generating data on a result of performing the question/mission with an exemplary answer to the question/mission stored in the database server, generating data on evaluation of the result, making a list of high ranked applicants who belong to a specified ranking based on the data on evaluation of the result, and transmitting the list of high ranked applicants to the university server.

22. The method according to claim 21, wherein the game server transmits the subject-based question/mission to the user terminal, evaluates on a result of performing the subject-based question/mission, generates first data on evaluation of the result, makes a list of recommended majors corresponding to subjects which get grades exceeding a specified grade based on the first data on evaluation of the result, and transmits the list of recommended majors.

23. The method according to claim 22, wherein the database server further stores a question/mission data for testing an aptitude for major, and the game server reads the question/mission data for testing an aptitude for major, transmits the question/mission data to the user terminal, and transmits to the user terminal the subject-based question/mission data corresponding to a type of major suitable for an aptitude of the applicant according to dada on evaluation on the result after receiving a result of performing the question/mission for testing the aptitude for major from the user terminal.

24. The method according to claim 22, wherein the game server receives selection information on the list of majors from the user terminal, transmits a major-based question/mission data corresponding to the selected major to the user terminal, receives a result of performing the major-based question/mission data from the user terminal, generate second data on evaluation of the result, and generates ranking information on the applicant in terms of the selected major according to the second data on evaluation of the result.

25. The method according to claim 24, wherein the game server opens an on-line interview room for the applicant who belongs to a specified ranking according to the ranking information, receives image and voice data on the applicant and image and voice data on an interviewer from the user terminal and the university server which are connecting to the on-line interview room, and transmits the image and voice data on the applicant and the image and voice data on the interviewer to the manager terminal and the user terminal, respectively.

26. The method according to claim 25, wherein the game server receives data on a result of conducting the on-line interview from the user terminal and generates a list of high ranked applicants whose grades are calculated by adding the data on the result of conducting the on-line interview and the second data on evaluation.
